(19) United States
(12) Patent Application Publication
(10) Pub. No.: US 2005/0214596 A1
(43) Pub. Date: Sep. 29, 2005

(54) Finish and process to create flame-retardant textile that resists mark-off

(76) Inventor: Robert C. Arnott, Spartanburg, SC (US)

Correspondence Address: Charlotte C. Wilson;Legal Department, M-495, PO Box 1926, Spartanburg, SC, 29304, US

(21) Appl. No.: 10/810,955

(22) Filed: Mar. 26, 2004

(51) Int. Cl. B32B 3/00

(52) U.S. Cl. 428/920; 442/136; 442/104; 442/141

(57) ABSTRACT

The present finish uses a durable elastic urethane polymer as the primary component blended with a smaller amount of low elongation urethane polymer to provide the desired hand for the finished fabric. This combination, in which the high elongation polymer basically surrounds the low elongation polymer, provides an economical way to prevent mark-off in the coated fabric. To meet flammability requirements, flame retardant chemistry is preferably applied to the fabric during dyeing, causing the flame retardant to be incorporated durably into the fiber. A process for applying this finish to create a flame retardant coated fabric is also described.

### TECHNICAL FIELD

The present disclosure relates to a low add-on polymeric finish for textile fabrics that provides a firm hand and that may provide flame retardant properties, while simultaneously resisting mark-off and yellowing over time. In addition, the polymeric finish described herein is substantially transparent, thereby allowing the color and/or pattern of the underlying fabric to be visible. Such a finish is particularly suited for use in a range of textile products, including, specifically, roller shades, vertical blinds, automotive upholstery, and other products where its properties are desirable.

### BACKGROUND

Flame retardance is an important feature in the production of many textile finishes that will be used in motor vehicles (such as recreation vehicles) and in residential and commercial settings. Previous attempts to create a flame retardant textile finish using various polymeric compositions have resulted in a problem known as “mark-off.” “Mark-off” refers to a visible defect exhibited by a finished or coated fabric when localized contact is made with the fabric (e.g., when the fabric is scratched), resulting in the break of the polymer finish or the separation of the polymer finish from the fabric, either of which leads to visible scratch lines in the area of localized contact. Generally speaking, mark-off is more noticeable in dark-colored fabrics.

Attempts to create a suitable polymer finish that resists mark-off and provides effective flame retardant properties have included efforts using a polymer with flame retardant molecular “backbones.” When such polyurethane finishes are used, the result is a relatively low elongation polymer finish that exhibits mark-off in knit fabrics, even when the finish is applied at low levels.

Using cross-linkable acrylic polymers to create the finish is problematic, because acrylics without flame retardant additives are generally incapable of passing most flammability tests. In attempting to create a flame retardant acrylic finish, the high level of particulate flame retardant required be incorporated into the acrylic polymer causes the coating to be slightly opaque. Furthermore, most cross-linkable acrylic finishes contain formaldehyde, which is generally not a commercially preferred ingredient.

Yet another approach used to create a flame retardant finish is to coat the textile with polyvinyl chloride (PVC). While capable of providing a finish that is flame retardant, PVC has the disadvantage of yellowing during processing, resulting in an undesirable appearance of the final product.

Finishing compositions incorporating aromatic bromine compounds and antimony oxide are successful at meeting the flame retardant requirements, but have the disadvantage of inviting close scrutiny with regard to toxicity concerns. For this reason, manufacturers tend to avoid the use of such compounds in creating flame retardant finishes.

The finish described herein overcomes the problems discussed above by providing the following advantages: (1) firm hand, flame retardance, and resistance to mark-off; (2) no formaldehyde; (3) non-yellowing over time or from exposure to sunlight; and (4) substantially transparent, allowing the colors, patterns, and/or textures of the underlying fabric to be seen. For these reasons, the present finish represents a useful advance over the prior art.

### SUMMARY

The present disclosure relates to a process for creating a flame retardant textile to which is applied a durable, transparent, non-yellowing, formaldehyde-free finish in order to produce a finished textile with firm hand and no mark-off problems. The finish is comprised of a combination of urethane polymers that includes a high elongation, flexible polymer and a low elongation polymer, in which the high elongation polymer acts as a binder for the low elongation polymer.

### DETAILED DESCRIPTION

High elongation polymers, as described herein, have an elongation at break of at least 500% and possibly as high as 1000%, and, preferably, have a Sward Rocker Hardness of 25 or less. The high elongation polymer component acts as a binding agent for the low elongation polymer component, providing flexibility in the fabric finish that enables the finish to resist mark-off.

Low elongation polymers, as described herein, typically have an elongation at break of less than 500%, and, preferably, exhibit a Sward Rocker Hardness of greater than 25. The low elongation polymer component of the finish provides hand firmness in the finished fabric.

While hardness and elongation are generally related (that is, polymers with high measurements on the Sward Rocker Hardness scale typically have low elongation), engineered polymers can have both a desired high elongation and a high degree of hardness, as measured on the Sward Rocker Hardness scale. One example of a polymer having a relatively high elongation and a high degree of hardness is an aromatic polyester urethane, sold by Noveon, Inc. of Cleveland, Ohio, under the tradename SANCURE® 12249.

However, aromatic polymers have a tendency to yellow from exposure to sunlight, making these types of polymers less desirable. For the intended applications described herein, aliphatic polymers, such as aliphatic polyester urethanes, aliphatic polyether urethanes, and aliphatic polycarbonate urethanes, are preferred because they do not tend to yellow.

One example of an aliphatic polyester urethane suitable for this application contains 48% solids and is sold by Noveon under the name SANCURE® 20025. This high elongation polymer has an elongation at break of about 1000% and has a hardness of about 5 when measured on the Sward Rocker Hardness scale.

Another example of an aliphatic polyester urethane suitable for this application contains 30% solids and is sold by Noveon under the name SANCURE® 1073. This preferred low elongation polymer, which exhibits an elongation at break of about 18% and a hardness of about 34 as measured on the Sward Rocker Hardness scale, includes a flame retardant monomer as part of the polymer backbone.

One example of an aliphatic polyether urethane is sold by Noveon under the tradename SANCURE® 2019, which exhibits a Sward Rocker Hardness of 4 and an elongation at break of about 500% (properties of a high elongation polymer). An example of an aliphatic polycarbonate urethane is sold by Stahl, USA under the tradename RU-41-342.

The ratio of high elongation polymer to low elongation polymer can vary, but, when using the SANCURE® urethanes described above, the preferred ratio is between about 20:1 and about 5:1, and more preferably about 10:1, based on the percentage of solids. The percent dry add-on of polymers applied to the textile can be as little as 2.5% of the weight of the fabric (owf), although more polymer blend could be added to create an even firmer hand if desired. The percent dry add-on may be within the range of about 2% owf to about 15% owf, preferably between about 2.5% to about 5.0%, more preferably between about 2.5% owf and about 3.5% owf, with about 3% owf being most preferred.

In attempting to create a flame retardant textile finish with the desired properties described above, one can either apply the flame retardant as part of a surface coating or apply the flame retardant to the base fabric before coating the surface. Generally, surface coatings may be one of two types: thermoset polymers and thermoplastic polymers.

Most thermoset polymers, especially when applied to polyester fabrics, tend to cross-link and form a film layer on the fabric surface rather than being partially incorporated therein (as are thermoplastic polymers that do not cross-link). Accordingly, thermoset polymers have a much greater tendency to fail the National Fire Prevention Association Small Scale 701 Vertical Flame Test (1989), making them incapable of meeting the flammability requirements associated with their intended use.

Several examples of non-cross-linking thermoplastic polymers are commercially available. Polymers of this type are sold by Noveon under the tradename SANCURE®, several of which have been previously mentioned; by C. L. Hauthaway & Sons Corporation of Lynn, Mass., under the tradename HAUTHANE®; and by Stahl, USA of Peabody, Mass., under various tradenames. Some of these polymers have flame retardant monomers incorporated into the polymer molecule, for the purpose of imparting flame retardant properties to the surface coating.

Initially, efforts to create a coating using only a low elongation polymer (into which a flame retardant monomer was incorporated) resulted in fabrics that, although capable of meeting flammability requirements, were susceptible to mark-off. The mark-off problem was observed, even with low dry add-on levels of coating, because these kinds of polymers lack the flexibility needed to resist breakage of the finish or separation of the finish from the fabric.

Efforts to use only a high elongation polymer improved the fabric's ability to resist mark-off. However, dry add-on levels of a high elongation polymer are necessarily much higher to obtain the desired hand (stiffness) in the finished fabric. Dry add-on levels of as much as 15% or more, while meeting the specification for hand, are less likely to meet flammability requirements.

Rather than relying on a polymer with an incorporated flame retardant, the flame retardant chemicals were incorporated in the fabric. The decision to incorporate flame retardant chemicals into the fabric allows more flexibility in selecting the polymer coating that is used.

In this preferred approach, the flame retardant chemistry (such as, for example, Flameproof 1503® flame retardant from Apex Chemical of Spartanburg, S. C.; FR-2-728 flame retardant from Milliken Chemical, a division of Milliken & Company, Spartanburg, S. C.; or Pyrozyl EF9® flame retardant from Amitech, Inc. of Oxford, N. J.) is exhausted into the fabric, preferably during the dyeing process. Pyrozyl EF9® flame retardant, which contains a chlorinated phosphate ester, is the preferred flame retardant for this application (i.e., when using 100% polyester knit fabrics).

In using this approach—that is, treating the textile with flame retardant before coating with polymer to provide hand—the textile and flame retardant are placed into a jet-dyeing machine and heated to temperature (e.g., 265° F.). The jet is held at temperature, preferably between 30 and 60 minutes, to allow the flame retardant to be exhausted into the textile, after which the textile is cooled and rinsed before further processing. This technique results in the flame retardant chemistry being durably incorporated into the fibers themselves. Weight analysis reveals that between 60% and 75% of the available flame retardant is typically incorporated into the fabric using this technique. The dyeing process, using disperse dyes, can be done before or, preferably, simultaneously with the flame retardant treatment. Lab and production results show the effectiveness of incorporating a flame retardant chemical into the fabric structure, rather than relying only on the fabric coating, to provide flame retardance.

To provide the flame retardant fabric prepared above with the desired hand (i.e., stiffness) and resistance to mark-off requires the use of a combination of a high elongation polymer and a low elongation polymer. A small amount of low elongation polymer blended with a higher percentage of high elongation polymer provides the flame retardant fabric with both the desired hand and resistance to mark-off.

Applying the polymer combination to the textile is easily accomplished by padding the fabric (a process in which the fabric is dipped in an aqueous solution containing a combination of urethane polymers and then passed through squeeze rolls to remove the excess). Other application methods such as spraying, single- or double-side foam coating, knife coating, and other techniques as are known in the art may be used, although padding is a preferred method.

### EXAMPLE 1

A 100% polyester raschel knit textile having 28×28 courses and wales, 150/36 yarns, and a weight of about 30 ounces per linear yard at 96 inches was used. Each 100 gram portion of the textile was put into a jet-dyeing machine with about 500 cc of water to wet the textile, after which a flame retardant chemical (Pyrozyl EF-9®, dispersed in about 200 grams of water) was added, at 6% of the weight of the fabric. Additional water was added to bring the total volume to 1500 cc. Each textile sample was heated by increasing the temperature to 265° F. at a rise rate of 12° F./minute. The solution was held at temperature for at least 30 minutes, after which the temperature was dropped and the textile samples were rinsed and dried.

A textile sample was padded into one of various solutions of polymer coating, using laboratory scale equipment at a roll pressure of 50 pounds per square inch, resulting in a wet pick-up of between 65% and 70%. Each sample was then placed on pin frames to maintain dimensional stability and dried at 380° F. for about 3 minutes. The samples were evaluated for mark-off problems and for desired hand as shown in Data Table 1.

DATA TABLE 1
Lab Scale Evaluation of Hand using Different Polymer Add-on

| | | Hand |
|---|---|---|
| Polymer | Textile | (grams) |
| (% solids in solution) | Color | (wales/courses) |
| SANCURE ® 20025 polyester | Gray | 504/178 |
| urethane | | |
| (5%) | | |
| SANCURE ® 20025 polyester | Gray | 694/272 |
| urethane | | |
| (10%) | | |
| Combination of SANCURE ® | Gray | 977/430 |
| 20037 polyester urethane (1%) | | |
| AND | | |
| SANCURE ® | | |
| 20025 polyester urethane (5%) | | |

Hand was evaluated using ASTM Test Method D6828-02, entitled “Standard Test Method for Stiffness of Fabric by the Blade/Slot Procedure.” Using this method, hand is a measure of the force necessary to bend a piece of fabric to fit into a 10 mm wide gap. Force is measured in grams, using a 4 inch×4 inch piece of fabric. The maximum reading is about 1000. When testing individual samples (using the same operator to test each sample), the standard deviation is 16 grams. The first number reported represents the force required to bend the fabric in the wales direction and the second number represents the force required to bend the fabric in the direction of the courses. Higher numbers indicate fabrics having a firmer hand, whereas lower numbers indicate a more flexible fabric.

For the intended applications contemplated for the present coated textile (e.g., roller shades), the hand should measure at least 900 grams in the wales direction and at least 400 grams in the courses direction. Obviously, other applications may have different hand requirements.

As is seen in the final sample of Data Table 1, the combination of a high elongation polymer and a smaller amount of a low elongation polymer provides the most desired stiffness in the final product. This combination produces fabric having a hand that is significantly better (for this application) than the fabric produced using twice as much high elongation polymer alone. In fact, many skilled in the art might believe it contradictory to use a high elongation (“soft”) polymer to create a stiff hand on a textile, although this approach (as described herein) is successful in achieving the desired textile stiffness. None of the samples exhibited any mark-off, despite their dark color.

The combination described above provides an economical means to obtain the desired stiffness. Simultaneously, the combination of polymer urethanes in a relatively low add-on level contributes to the flame retardant properties by minimizing the likelihood of flame spreading, due to presence of a high amount of coating on the surface of the fabric.

### EXAMPLE 2

A 100% polyester raschel knit textile having 28×28 courses and wales, 150/36 yarns, and a weight of about 30 ounces per linear yard at 96 inches was used. In a jet-dyeing machine, the following solution was constructed (all percentages are by weight of the fabric): 4% Pyrozyl EF9® flame retardant from Amitech; 0.4% acetic acid used to control pH; 0.75% Leveler 528, an additive used to ensure color uniformity; 0.5% Defoamer RE™, a defoaming agent used to ease processing; and 5% of a combination of disperse dyes to yield a black color. The fabric was added to the jet, and the temperature was increased to a temperature of about 160° F. at a rise rate of about 40/minute. The temperature was further increased to a temperature of about 280° F. at a rise rate of about 20/minute. This higher temperature was held for about 30 minutes, after which the fabric was cooled at a drop rate of about 20/minute. Finally, the dyed, flame retardant-treated fabric was removed from the jet and rinsed.

The fabric was padded with an aqueous polymer solution containing 5% SANCURE® 20025 polyester urethane (48% solids) on a solids basis and 0.5% SANCURE® 1049C polyester urethane (30% solids) on a solids basis. The ratio of high elongation polymer to low elongation polymer was approximately 10:1, on a solids basis. The wet add-on of the polymer solution was about 65% at a pad pressure of about 50 psi. The coated fabric was then dried at a temperature of 390° F. for about 1.5 minutes.

When complete, the finished textile exhibited no mark-off and a hand measurement of 970 grams in the wales direction and 440 grams in the courses direction. The flammability results, when the textile was tested according to NFPA Small Scale 701 Vertical Flame Test (1989), are shown in DATA TABLE 2A.

DATA TABLE 2A
Flammability of Production-Scale Coated Textile (Black Sample)

| | | Length of | | |
|---|---|---|---|---|
| | Length of burn | burn in | Length of after- | Drip time |
| | in wales | courses | flame time | (seconds) |
| | direction | direction | (seconds) | (wales; |
| Sample # | (inches) | (inches) | (wales; courses) | courses) |
| 1 | 3.40 | 3.86 | 0; 0 | 0; 0 |
| 2 | 4.38 | 4.22 | 0; 0 | 0; 0 |
| 3 | 4.54 | 4.84 | 0; 0 | 0; 0 |
| 4 | 4.08 | 3.98 | 0; 0 | 1; 0 |
| 5 | 3.50 | 3.30 | 0; 0 | 0; 1 |
| Average | 3.98 | 4.04 | 0; 0 | 0.2; 0.2 |

A second fabric was produced using the same methods described above, but using a combination of disperse dyes to create a thistle-colored product. The flammability testing results of the thistle-colored coated textile, when tested according to NFPA Small Scale 701 Vertical Flame Test (1989), are shown in DATA TABLE 2B.

DATA TABLE 2B
Flammability of Production-Scale Coated Textile
(Thistle-colored Sample)

| | | Length of | | |
|---|---|---|---|---|
| | Length of burn | burn in | Length of after- | Drip time |
| | in wales | courses | flame time | (seconds) |
| | direction | direction | (seconds) | (wales; |
| Sample # | (inches) | (inches) | (wales; courses) | courses) |
| 1 | 2.98 | 4.36 | 0; 0 | 0; 1 |
| 2 | 3.80 | 3.12 | 0; 0 | 0; 1 |
| 3 | 4.50 | 3.38 | 0; 0 | 0; 1 |
| 4 | 3.62 | 3.74 | 0; 0 | 0; 1 |
| 5 | 4.10 | 3.86 | 4; 0 | 1; 0 |
| Average | 3.80 | 3.69 | 0.8; 0 | 0.2; 0.8 |

The production-scale trials confirm that the process of exhausting a flame retardant chemical into the fabric and then coating it with a combination of a high elongation polymer and a low elongation polymer provides the desired properties for the present fabric. Specifically, the coated fabric (1) possesses the desired stiffness for its intended applications and (2) meets flammability requirements. Furthermore, the coating is transparent, allowing the color of the underlying fabric to be readily appreciated.

### CONCLUSION

Although the preferred combination of high elongation and low elongation polymers has been shown for use on knit fabrics, it is contemplated that similar benefits may be obtained on other textile constructions, such as woven or nonwoven fabrics. Further, although the process of exhausting a flame retardant chemical into a fabric during dyeing has been shown for use with polyester fabrics, it is contemplated that similar results may be obtained using other fiber types.

The coating may further include chemistries designed to enhance ultraviolet absorption, ultraviolet inhibitors, antimicrobials, mildew inhibitors, water repellents, soil release chemistries, polychromatic chemistries, odor absorbents, or the like.

In conclusion, the process of (a) exhausting a flame retardant into a fabric and then (b) coating the textile with a combination of high elongation polymer and low elongation polymer is capable of creating a flame retardant fabric with a desired hand and resistance to mark-off. Using a coating comprising the combination of a high elongation polymer and a low elongation polymer in a ratio ranging between about 20:1 to about 5:1 provides the desired firmness in the coated fabric in an economical manner, while also assisting in maintaining the flame retardant characteristics of the underlying fabric.

These features are further complemented by the fact that the present finish (1) contains no formaldehyde; (2) does not yellow over time or from exposure to sunlight; and (3) provides a substantially transparent coating through which the colors, patterns, and/or texture of the underlying fabric can be seen. For all of these reasons and benefits, the present finish and process represent useful advances over the prior art.

1. A textile finish resistant to mark-off, in which said finish comprises a combination of a first urethane polymer having an elongation at break of at least 500% and a second urethane polymer having an elongation at break of less than 500%, wherein the ratio of said first urethane polymer to said second urethane polymer is between about 20:1 and about 5:1 on a solids basis.

2. The textile finish of claim 1, wherein the ratio of said first urethane polymer to said second urethane polymer is about 10:1 on a solids basis.

3. The textile finish of claim 1, wherein said first urethane polymer and said second urethane polymer are selected from the group consisting of aliphatic polyesters, aliphatic polyethers, and aliphatic polycarbonates.

4. The textile finish of claim 1, wherein said first urethane polymer is an aliphatic polyester urethane.

5. The textile finish of claim 1, wherein said second urethane polymer is an aliphatic polyester urethane.

6. The textile finish of claim 1, wherein a flame retardant compound is incorporated into the molecular backbone of at least one of said urethane polymers.

7. The textile finish of claim 1, wherein said first urethane polymer has a hardness of between about 5 and about 25 on the Sward Rocker Hardness scale.

8. The textile finish of claim 1, wherein said second urethane polymer has a hardness of greater than about 25 on the Sward Rocker Hardness scale.

9. A process for making a flame retardant coated fabric, said process comprising the steps of:
(a) providing a fabric;
(b) processing said fabric in a jet-dyeing machine to exhaust a flame retardant chemical into said fabric; and
(c) coating said flame retardant fabric with a polymer finish, said polymer finish comprising a combination of a first urethane polymer having an elongation of at least 500% and a second urethane polymer having an elongation of less than 500%, wherein the ratio of said first urethane polymer to said second urethane polymer is between about 20:1 and about 5:1 on a solids basis.

10. The process of claim 9, wherein said fabric has a knit construction.

11. The process of claim 9, wherein said fabric has a raschel knit construction.

12. The process of claim 9, wherein said flame retardant chemical contains a chlorinated phosphate ester.

13. The process of claim 9, wherein said fabric is dyed during step (b), using disperse dyes.

14. The process of claim 9, wherein step (c) is accomplished by padding an aqueous solution of said first urethane polymer and said second urethane polymer onto said fabric.

15. The process of claim 9, wherein said first urethane polymer has a hardness of between about 5 and about 25 on the Sward Rocker Hardness scale and said second urethane polymer has a hardness of greater than about 25 on the Sward Rocker Hardness scale.

16. The process of claim 15, wherein the dry add-on level of said polymer finish is between about 2% and about 15%.

17. The process of claim 16, wherein said dry add-on level of said polymer finish is between about 2.5% and about 5%.

18. The process of claim 9, wherein said first urethane polymer and said second urethane polymer are selected from the group consisting of aliphatic polyesters, aliphatic polyethers, and aliphatic polycarbonates.

19. The process of claim 18, wherein said first urethane polymer and said second urethane polymer are aliphatic polyesters.

20. The process of claim 18, wherein a flame retardant compound is incorporated into the molecular backbone of at least one of said urethane polymers.

21. A fabric product, said fabric product comprising:
(a) a fabric comprising a plurality of yarns into which a flame retardant chemical has been incorporated,
(b) a polymer finish applied to said fabric, said polymer finish comprising a combination of a first urethane polymer having an elongation at break of at least 500% and a second urethane polymer having an elongation at break of less than 500%, wherein the ratio of said first urethane polymer to said second urethane polymer is between about 20:1 and about 5:1 on a solids basis.

22. The fabric product of claim 21, wherein said fabric has a knit construction.

23. The fabric product of claim 21, wherein said fabric has a woven construction.

24. The fabric product of claim 21, wherein said fabric has a nonwoven construction.

25. The fabric product of claim 21, wherein said flame retardant chemical contains a chlorinated phosphate ester.

26. The fabric product of claim 21, wherein said polymer finish is transparent.

27. The fabric product of claim 21, wherein the dry add-on level of said polymer finish is between about 2% and about 15%.

28. The fabric product of claim 24, wherein said dry add-on level of said polymer finish is between about 2.5% and about 5%.

29. The fabric product of claim 21, wherein said first urethane polymer and said second urethane polymer are selected from the group consisting of aliphatic polyesters, aliphatic polyethers, and aliphatic polycarbonates.

30. The fabric product of claim 29, wherein said first urethane polymer and said second urethane polymer are aliphatic polyesters.

31. The fabric product of claim 21, wherein said fabric product passes the NFPA Small Scale 701 Vertical Flame Test (1989).

32. The fabric product of claim 22, wherein said fabric product has hand of at least 900 grams in the wales direction and at least 400 grams in the courses direction, as measured according to ASTM Test Method D6828-02.
